(19) United States
(12) Patent Application Publication
(10) Pub. No.: US 2008/0009150 A1
(43) Pub. Date: Jan. 10, 2008

(54) CHIP CONNECTION DEVICE

(76) Inventor: KUANG-CHIH LAI, Tu-Cheng City (TW)

Correspondence Address: LEONG C LEI, PMB # 1008, 1867 YGNACIO VALLEY ROAD, WALNUT CREEK, CA, 94598, US

(21) Appl. No.: 11/769,714

(22) Filed: Jun. 28, 2007

(30) Foreign Application Priority Data
Jul. 5, 2006 (TW) 095124425

(51) Int. Cl. H01R 12/00

(52) U.S. Cl. 439/71

(57) ABSTRACT

The chip connection device's main feature is a structurally simple and rigid engagement member. The engagement member mainly contains a knob having only a top cylinder for turning and indication, an eccentric base cylinder to cause reliable relative lateral movement of the top and base plates of the chip connection device, and a flange between the top and base cylinders. The flange is sandwiched between a top board and a base board of the engagement member and the engagement member is in turn housed between the extensions from the top and base plates of the chip connection device. A clamping member is further provided to clamp the extensions from the top and base plates vertically together and, therefore, the plates can only be engaged into relative lateral movement.

### BACKGROUND OF THE INVENTION

(a) Technical Field of the Invention

The present invention generally relates to electronic connection devices, and more particularly to a chip connection device capable of achieving superior electrical connectivity by the relative lateral displacement of the chip's top and base plates.

(b) Description of the Prior Art

Chip connection devices are commonly found in computing devices. As the chips are constantly upgrading and getting more complicated, the chip connection devices are facing greater challenges which, on one hand, require superior electrical connectivity to the great number of delicate pins of the chips and, on the other hand, require easy installation and removal of the chips to and from a circuit board.

FIG. 14 is a conventional chip connection device taught by R.O.C. (Taiwan) Patent Publication No., 250387. As illustrated, the chip connection device contains a base plate A1 with pin holes A2 each having a terminal C1 inside, a top plate B1 with pin holes B2 corresponding to the pin holes A2, a protection member D1, and an engagement member E1.

On the top surface of the base plate A1, there is a T-shaped indentation A4 with a through hole A3 in the center. The protection member D1 contains a T-shaped base board D3 and a T-shaped top board D2, both made of a metallic material. The base board D3 has a rectangular through opening D4 in the center and is positioned inside the indentation A4 of the base plate A1. The top board D2 is positioned in an indentation (not shown) on the bottom surface of the top plate B1. The top plate B1 has a through hole B3 in the center of the indentation. The circumference of the through hole B3 consists of a larger arc and a smaller arc. There are two corners B4 formed at where the two arcs interface with each other.

The top board D2 has an elongated through slot D5 whose middle section is curved outward to form two arcs D6. From the circumference of the slot D5, two blocks D7 are extended upward and, when assembled, the two blocks D7 are adjacent to the corners B4 of the top plate B1.

The engagement member E1 is integrally formed to have a number of cylinders stacked vertically. From top to bottom and in decreasing diameters, there are a first cylinder E3, a second cylinder E4, a third cylinder E5, and fourth cylinder E6 which, when assembled, will be in the through hole or opening B3, D5, D4, and A3, respectively. At the interfaces between the cylinders and the boards and plates, a number of washers F1 are used. A block E2 is extended from the circumference of the cylinder E3.

The operation of the chip connection device is as follows. First, a chip is positioned on the top plate B1 so that its pins penetrate through the pin holes B2 and A2. As the engagement member E1 is turned so that the block E2 is swung from one corner B4 to another, the top plate B1 is laterally displaced, relative to the base plate A1 (as the base plate A1 is fixed on the circuit board). As such, the pins of the chip are moved to establish reliable electrical contact with the terminals C1 inside the pin holes A2.

The disadvantages of the foregoing chip connection device are as follows. First, the structure of the engagement member E1 is too complicated and therefore is difficult to manufacture. Secondly, the blocks E2 and D7 are the most vulnerable parts of the device and their strength should be reinforced. In addition, the positioning of the engagement member E1 is not reliable; some external impact would easily cause the engagement member E1 to escape from the chip connection device.

### SUMMARY OF THE INVENTION

The primary purpose of the present invention is to provide a structurally simple and rigid engagement member to achieve the relative lateral movement of the top and base plates of the connection device. To achieve this objective, the engagement member of the present invention mainly contains a knob having only a top cylinder for turning and indication and an eccentric base cylinder to cause reliable relative lateral movement.

A second objective of the present invention is to achieve reliable and robust positioning of the engagement member. To achieve this objective, the knob of the engagement member contains a flange between the top and base cylinders. The flange is sandwiched between a top board and a base board of the engagement member and the engagement member is in turn housed between the extensions from the top and base plates of the chip connection device.

A third objective of the present invention is to achieve strict and smooth lateral relative movement of the top and base plates of the chip connection device. To achieve this objective, a clamping member is provided to clamp the extensions from the top and base plates vertically together and, therefore, the plates can only be engaged into relative lateral movement.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a chip connection device according to an embodiment of the present invention in a top-down angle.

FIG. 2 is a perspective exploded view showing the various components of the chip connection device of FIG. 1.

FIG. 3 is a perspective enlarged view showing the details in the circle A of FIG. 2.

FIG. 4 is a perspective exploded view showing the various components of the chip connection device of FIG. 1 in a bottom-up angle.

FIG. 5 is a perspective exploded view showing the various components of the engagement member of the chip connection device of FIG. 1.

FIGS. 6 and 7 are perspective and perspective sectional views showing the engagement member of the chip connection device of FIG. 1 when it is not engaged.

FIGS. 8 and 9 are perspective and perspective sectional views showing the engagement member of the chip connection device of FIG. 1 during its engagement.

FIGS. 10 and 11 are perspective and perspective sectional views showing the engagement member of the chip connection device of FIG. 1 after its engagement.

FIGS. 12 and 13 are enlarged perspective sectional views showing the interactions between the chip's pins and the terminals before and after the chip connection device is engaged, respectively.

FIG. 14 is a perspective exploded view showing the various components of a conventional chip connection device.

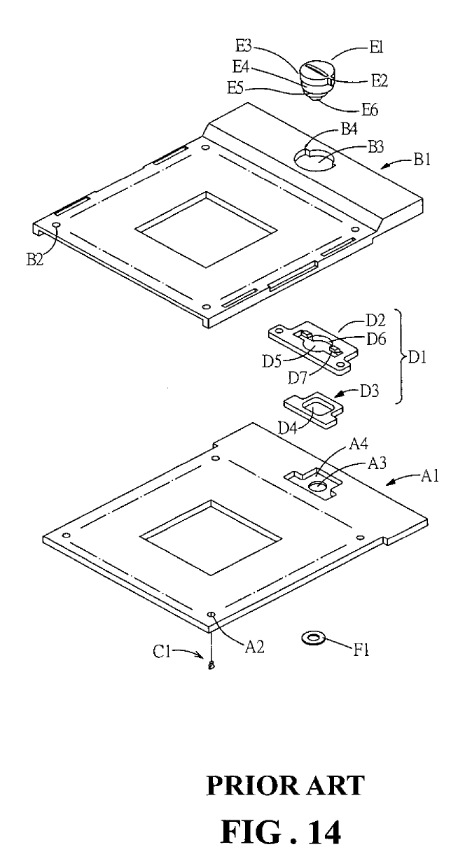

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

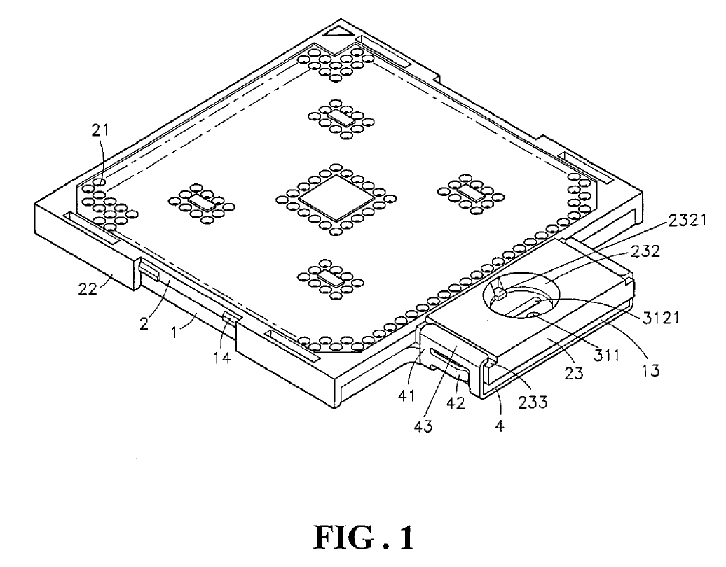

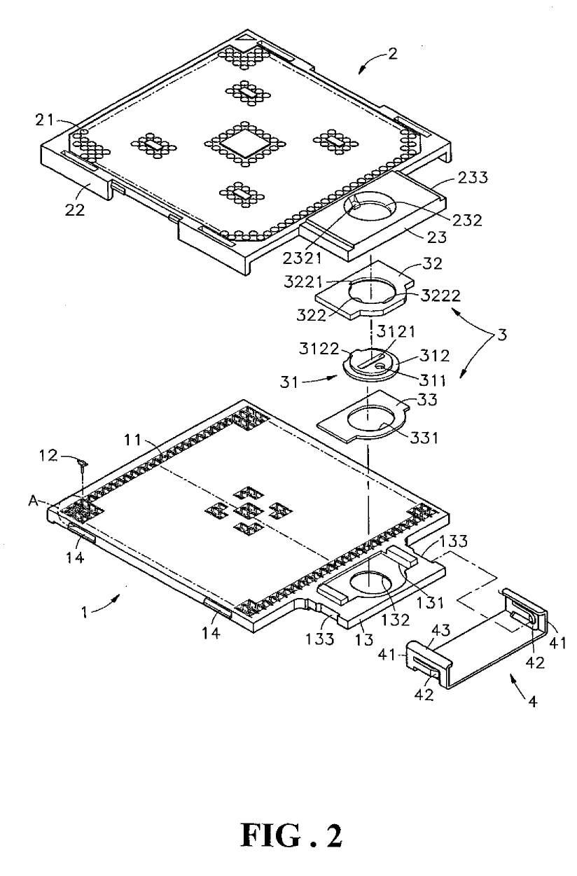

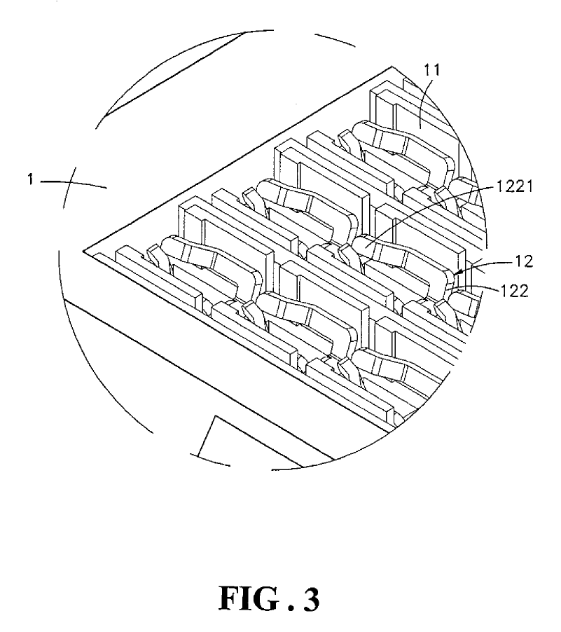

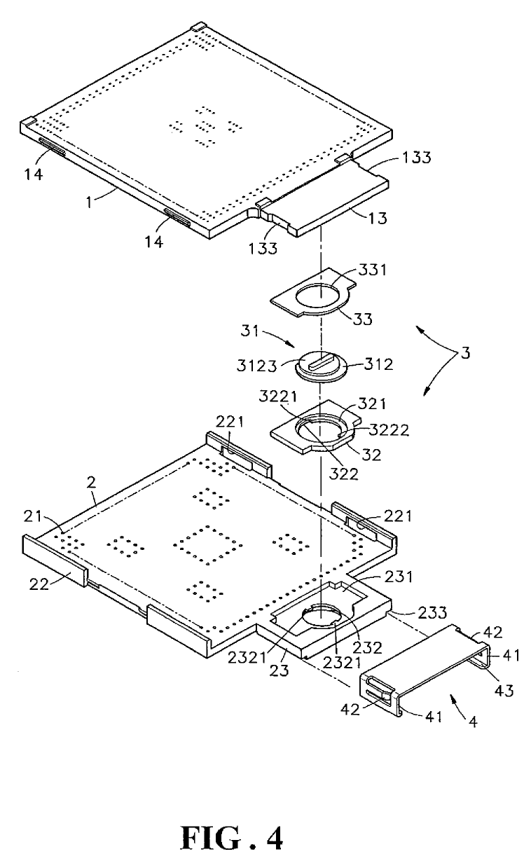

As shown in FIGS. 1 to 4, an embodiment of the present invention contains a rectangular base plate 1, a rectangular top plate 2, and an engagement member 3. The base plate 1 has an array of pin holes 11 and each pin hole 11 allows the accommodation of a terminal 12. The terminals 12 are extended downward through the base plate 1 so as to be soldered to the electrical contact points of a circuit board. On the other hand, as shown in FIG. 3, each terminal 12 contains two oppositely positioned conducting pieces 122 extended laterally toward a front direction and closing in towards each other at their end sections 122. Along two opposing sides (hereinafter a first side and a second side) in the front-back direction of the base plate 1, there are a number of retainer elements 14, respectively. Along a third side, the base plate 1 has a first extension 13. The first extension 13 has an indentation 131 on the top surface with a through hole 132 in the center of the indentation 131. Along each of two opposing sides (hereinafter a first side and a second side) in the front direction perpendicular to the third side of the base plate 1, the first extension 13 has a notch 133.

The top plate 2 is positioned on top of and joined to the base plate 1. The top plate 2 also has an array of pin holes 21, corresponding to the pin holes 11 of the base plate 1. Along two opposing sides (hereinafter the first and second sides) in the front direction of the top plate 2 that are adjacent to the first and second sides of the base plate 1, there are a number of latch element s 22 each with a hook 221 on the inner surface for engaging the retainer elements 14 of the base plate 1 when the cover and base plates 1 and 2 are joined together. Along a third side of the top plate 2 that is adjacent to the third side of the base plate 1, the top plate 2 has a rectangular second extension 23. The second extension 23 has an indentation 231 on the bottom surface with a through hole 232 in the center of the indentation 231. Along each of two opposing sides (hereinafter a first side and a second side) in the front direction perpendicular to the third side of the top plate 1, the second extension 23 has a side-to-side step 233.

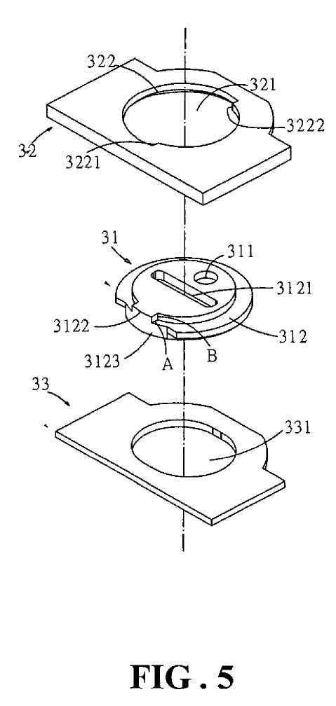

the engagement member 3 is positioned inside the space formed by the indentations 131 and 231 of the first and second extensions 13 and 23. The engagement member 3 has a knob 31 sandwiched between a base board 33 and a top board 32. The base board 33 and the top board 32 can be made of a metallic material. The knob 31 has a circular flange 312 with a missing segment. On top of the circular flange 312, there is a slim top cylinder (not numbered) in the center. The cylinder has a radial block 3122 extended from the circumference (see point B of FIG. 5) outwards to the chord of the missing segment (see point A of FIG. 5). On top of the cylinder, there is a diametric slot 3121 and a small blind hole 311 opposite said radial block 3122 across the slot 3121. Beneath the circular flange 312, there is a slim base cylinder 3123 positioned eccentrically and adjacent to the chord of the missing segment. Right beneath the base cylinder 3123 and the diametric slot 3121, there is a stick (not numbered) parallel to and of substantially the same length as the diametric slot 3121. The base board 33 contains a through hole 331 for accommodating the base cylinder 3123. On the other hand, the top board 32 contains a through hole 321 for accommodating the top cylinder. The circumference of the hole 321 consists of a larger arc 322 and a smaller arc (not numbered), each spanning about 180 degrees, that are located next to the first sides and the second sides of the first and second extensions 13 and 23, respectively. At where the larger arc 322 meets the smaller arc, thereby, two corners 3221 and 3222 are formed.

Along the circumference of the through hole 232 of the second extension 23, there are two opposing protrusions 2321 across the center right adjacent to the corners 3221 and 3222 of the top board 32. As shown in FIG. 1, the relative position of the blind hole 311 against the protrusions 2321 indicates the operation status of the engagement member 3.

As shown in FIG. 5, the assembly of the engagement member 3 is as follows. First, the base board 33 and the top board 32 are placed inside the indentations 131 and 231, respectively. Then, the knob 31 has its top cylinder fitted inside the through hole 321 of the top board 32 and the top plate 2 are joined to the base plate 1. The flange 312 is therefore interposed between the top board 32 and the base board 33; and the base cylinder 3123 is inside the through hole 331 of the base board 33. The radial block 3122 and the corners 3221 and 3222 together define a range limiting the turn of the knob 31.

Additionally, a U-shaped clamping member 4 is installed laterally to clamp the first and second extensions 13 and 23 together, so as to prevent the first and second extensions 13 and 23 from separation when the knob 31 is operated. The clamping member 4 has two vertical arms 41 for clamping the first and second extensions 13 and 23 by their first and second sides. The top portions 43 of the arms 41 are bended towards each other and received by the steps 233 of the second extension 23. In the middle section of each arm 41, there is a laterally positioned flexible stick 42 so that, when the clamping member 4 is slipped on the first and second extensions 13 and 23, the sticks 42 will stick into the notches 133 of the first extension 13. The clamping member 4 can be made of a metallic material.

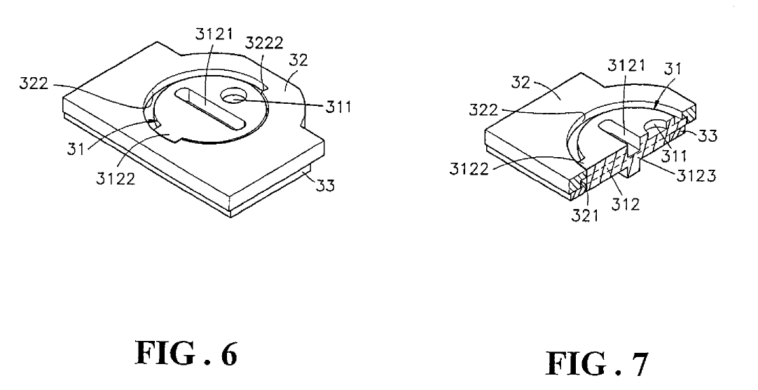

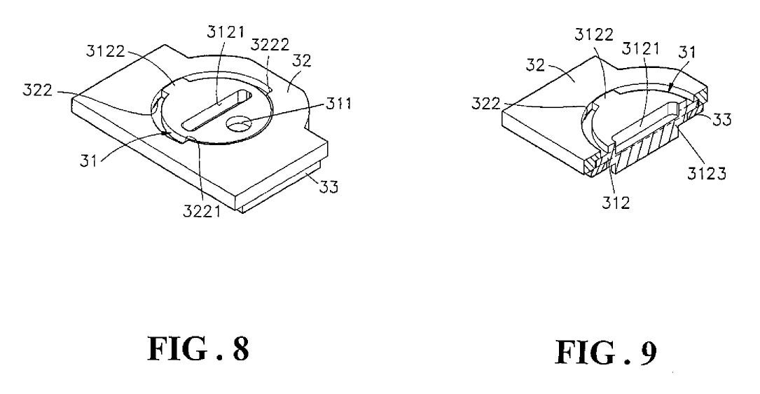

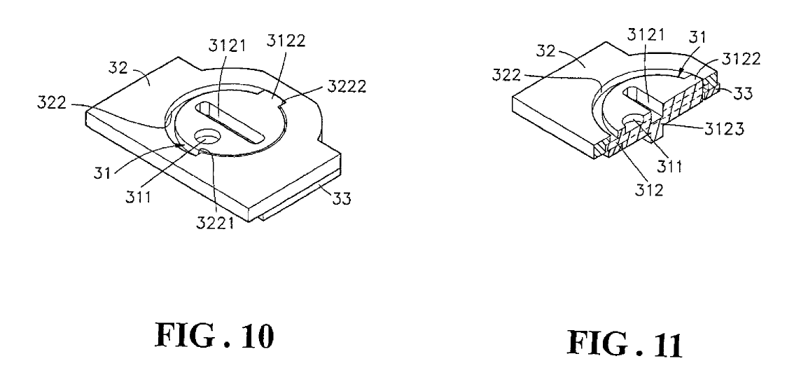

FIGS. 6 to 11 illustrate the operation of the engagement member 4. To use the engagement member 4, a hand tool such as a screwdriver with the cabinet tip is inserted into the slot 3121 to turn the knob 31. Initially, the status of the knob 31 is shown in FIGS. 6 and 7. During the course of turning the knob 31, the radial block 3122 is swung from the corner 3221 towards the corner 3222. In the mean time, the eccentric base cylinder 3123 at the bottom of the knob 31 is turned as well, which will push the circumference of the through hole 331 of the base board 33. As the base plate 1 (and therefore the base board 33) is fixed to a circuit board, the top board 32 (and therefore the top plate 2) is, in turn, advanced laterally in the front direction, as shown in FIGS. 8 and 9. As the radial block 3122 is turned all the way to the corner 3222, the top plate 1 will achieve the greatest distance of lateral advancement relative to the base plate 1, as shown in FIGS. 10 and 11. In other words, as the knob 31 is turned, its bottom eccentric base cylinder 3123 is tuned as well to exert force on the fixed base plate 1. The counter force in turn causes the top plate 2 to slide in the front direction relative to the base plate 1.

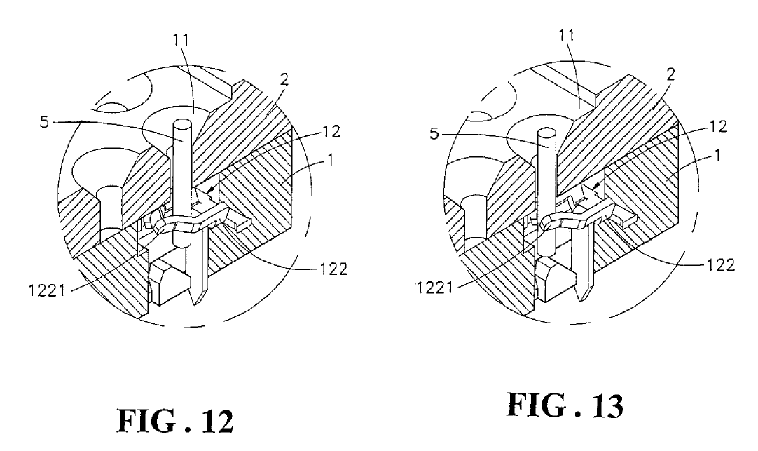

FIGS. 12 and 13 show the configurations of the chip connection device before and after a chip is “locked.” As shown in FIG. 12, initially, the knob 31 of the chip connection device is at an “open” status (i.e., the base plate 1 and the top plate 2 have no relative lateral displacement). A chip is placed on top of the top plate 2 with its pins 5 penetrating through the pin holes 21 of the top plate 2 into the pin holes 11 of the base plate 1. As illustrated, the pins 5 do not have any contact with the conducting pieces 122 of the terminals 12. By turning the knob 31 so that the radial block 3122 is swung from the corner 3221 to the corner 3222, as described earlier, the top plate 2 is shifted in the front direction. As shown in FIG. 13, the lateral displacement of the top plate 2 in the front direction causes the chip's pins 5 to slide between the end sections 1221 of the conducting pieces 122 to achieve reliably electrical conductivity between the pins 5 and the terminals 12. To remove the chip, the knob 31 is turned from this “closed” status until the radial block 3122 is swung back to the corner 3221 (i.e., the “open”status). The lateral and reversed displacement of the top plate 2 causes the chip's pins 5 to break out of the end sections 1221, as shown in FIG. 12. The chip then can be removed out of the chip connection device of the present invention.

Please note the blind hole 311 functions as an indicator of the knob 31's status. In alternative embodiments, this indicator can also be implemented as a small bump. In addition, the slot 3121 has an elongated shape for turning the knob 31 by a screwdriver with a cabinet tip. In other embodiments, the slot 3121 can have other appropriate shapes such as a cross or a hexagon for turning by a screwdriver with Philips tip and a hex wrench, respectively.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A chip connection device comprising:
a plurality of terminals each having two oppositely positioned conducting pieces extended laterally toward a front direction and closing in towards each other;
a rectangular base plate fixed on a circuit board having a plurality of pin holes, each having a terminal inside, said base plate having a first extension along a third side perpendicular to said front direction, said first extension having an indentation on a top surface of said first extension;
a rectangular top plate positioned on top of said base plate, said top plate having a plurality of pin holes corresponding to said pin holes of said base plate, said top plate having a second extension along a third side perpendicular to said front direction, said second extension having an indentation on a bottom surface of said second extension, said indentation of said second extension having a through hole;
an engagement member having a knob, a base board, and a top board, wherein
said knob has a substantially circular flange sandwiched between said base board and said top board;
on top of said flange, there is a top cylinder and a block adjacent to the circumference of said flange;
on a top surface of said top cylinder, there is an engagement groove for turning said knob;
beneath said flange, there is an eccentric base cylinder;
said base board is positioned inside said indentation of said first extension and has a through hole for accommodating said base cylinder;
said top board is positioned inside said indentation of said second extension and has a through hole allowing said top cylinder to penetrate through and expose from said through hole of said second extension;
the circumference of said through hole of said top board consists of a larger arc and a smaller arc and two corners at where said larger and smaller arcs interface;
said corners defines a range limiting the course of turning of said block of said knob; and
when said knob is turned, said eccentric base cylinder pushes said base board and thereby said base plate, the counter force in turn pushes said top board and thereby said top plate into lateral displacement movement relative to said base plate along said front direction.

2. The device according to claim 1, wherein said indentation of said first extension has a through hole.

3. The device according to claim 1, wherein a plurality of retained elements are positioned along two opposing sides of said base plate along said front direction, respectively, a plurality of latch elements are positioned along two opposing sides of said top plate along said front direction, respectively; and at least a latch element locks to a retainer element when said top plate is positioned on said base plate.

4. The device according to claim 3, wherein said latch element has a hook on an inner surface of said latch element for locking said retainer element.

5. The device according to claim 1, wherein, along the circumference of said through hole of said second extension, there are two opposing protrusions across the center of said through hole.

6. The device according to claim 5, wherein said protrusions are adjacent to said corners of said top board, respectively.

7. The device according to claim 1, wherein said block of said knob is extended from the circumference of said top cylinder.

8. The device according to claim 1, wherein, on said top surface of said top cylinder, there is a blind hole for indicating the current status of said engagement member.

9. The device according to claim 1, wherein, on said top surface of said top cylinder, there is a bump for indicating the current status of said engagement member.

10. The device according to claim 1, wherein said engagement groove is a slot.

11. The device according to claim 1, wherein said engagement groove has a cross shape.

12. The device according to claim 1, wherein said engagement groove has a hexagonal shape.

13. The device according to claim 1, wherein said at least one of said base board and said top board is made of a metallic material.

14. The device according to claim 1, further comprising a U-shaped clamping member having two vertical arms holding said first and second extensions vertically together along said front direction so that said base and top plates are capable of lateral displacement only.

15. The device according to claim 14, wherein said top portions of said arms are bended towards each other and received by side-to-side steps along two opposing sides of said second extension in said front direction, respectively.

16. The device according to claim 14, wherein, in a middle section of each arm, there is a laterally positioned flexible stick so that, when said clamping member is installed, said sticks stick into two notches along two opposing side of said first extension in said front direction, respectively.

17. The device according to claim 14, wherein said clamping member is made of a metallic material.
